(19) United States
(12) Patent Application Publication
(10) Pub. No.: US 2007/0075935 A1
(43) Pub. Date: Apr. 5, 2007

(54) Flat-panel display with hybrid imaging technology

(76) Inventors: Ralph Mesmer, Banks, OR (US); Achintya K. Bhowmik, Milpitas, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/241,676

(22) Filed: Sep. 30, 2005

(51) Int. Cl. G09G 3/30

(52) U.S. Cl. 345/76

(57) ABSTRACT

An embodiment of the present invention is a technique to provide a hybrid imaging display. An array of pixel units is formed. Each pixel unit has emissive and reflective sub-pixels. A sensor senses ambient light condition to generate a sense signal. A drive circuit generates driving signals to drive the array of pixel units according to the sense signal such that the emissive and reflective sub-pixels are switched in a mutually exclusive manner.

### BACKGROUND

1. Field of the Invention

Embodiments of the invention relate to the field of display technology, and more specifically, to flat-panel display.

2. Description of Related Art

Flat-panel displays have become increasingly popular in many applications including television, notebook computers, laptop and desktop personal computers (PC's), cellular phones, game consoles, mobile devices, personal digital assistants (PDA's), etc. Among the various display technologies, Thin-Film Transistor (TFT) Liquid Crystal Display (LCD) technology has gained a large share of today's market. However, one major problem with TFT-LCD displays is that it is good either indoor or outdoor uses, but not both. Transmissive TFT-LCD's are good for indoor uses, but are poor for outdoor uses because the brightness levels are degraded by sunlight. On the other hand, reflective TFT-LCD's are reasonable for outdoor viewing but are very poor in low ambient light conditions.

Transflective LCD's attempt to solve the above problem by combining reflective LCD technology with back-lit transmissive LCD technology. However, the display quality is a compromise between the two technologies. It does not provide the best viewing in either lighting condition.

### BRIEF DESCRIPTION OF THE DRAWINGS

Embodiments of invention may best be understood by referring to the following description and accompanying drawings that are used to illustrate embodiments of the invention. In the drawings:

FIG. 1A is a diagram illustrating a mobile device in which one embodiment of the invention can be practiced.

FIG. 1B is a diagram illustrating a processing system in which one embodiment of the invention can be practiced.

FIG. 2 is a diagram illustrating a hybrid imaging display unit according to one embodiment of the invention.

FIG. 3 is a diagram illustrating a drive circuit according to one embodiment of the invention.

FIG. 4 is a flowchart illustrating a process to display using hybrid imaging according to one embodiment of the invention.

FIG. 5 is a flowchart illustrating a process to generate driving signals according to one embodiment of the invention.

### DESCRIPTION

An embodiment of the present invention is a technique to a hybrid imaging display. An array of pixel units is formed. Each pixel unit has emissive and reflective sub-pixels. A sensor senses ambient light condition to generate a sense signal. A drive circuit generates driving signals to drive the array of pixel units according to the sense signal such that the emissive and reflective sub-pixels are switched in a mutually exclusive manner.

In the following description, numerous specific details are set forth. However, it is understood that embodiments of the invention may be practiced without these specific details. In other instances, well-known circuits, structures, and techniques have not been shown to avoid obscuring the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

One embodiment of the invention is a technique to display good image or graphic data in any lighting condition, such as outdoor and indoor, on a flat-display panel. The technique employs a hybrid imaging technology that combines emissive image generation such as Organic Light Emitting Diode (OLED) or Polymer Light Emitting Diode (PLED) and reflective image generation such as bi-stable Thin-Film Transistor (TFT) Liquid Crystal Display (LCD). Each pixel unit in an array of pixel units of the display includes the emissive and reflective sub-pixels. The sub-pixels may be turned on depending on the ambient light condition as provided by a light sensor. The implementation of such a hybrid technology display also allows for ink-jet printing of the active sub-pixels for low-cost displays. The pairing of the OLED/PLED with a bi-stable LCD display is an ideal embodiment.

Embodiments of the invention have numerous applications in portable, hand-held, and mobile devices such as Digital Versatile Disk (DVD) players, cellular phones, notebook personal computers (PC's), portable image viewers, cameras, video cameras, personal digital assistants (PDA's), or any devices that may need high display quality for viewing in both outdoor and indoor environments.

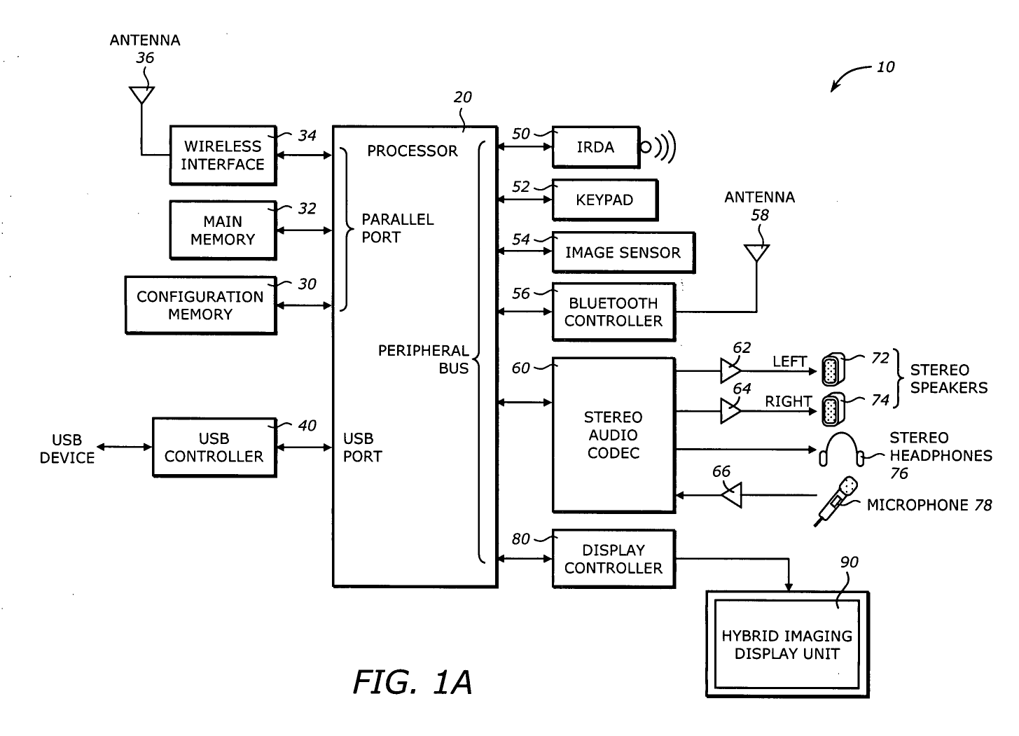

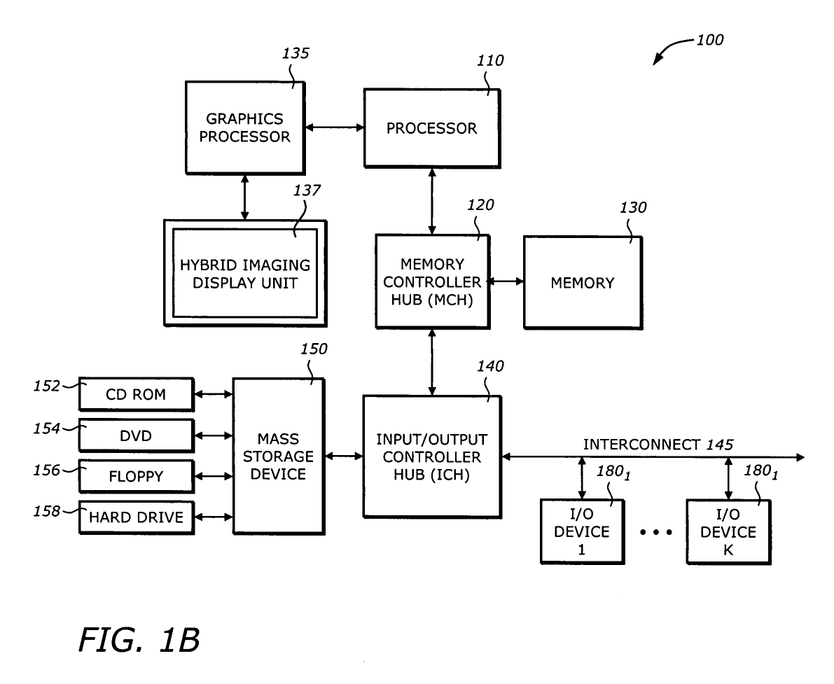

FIG. 1A is a diagram illustrating a mobile device 10 in which one embodiment of the invention can be practiced. The mobile device 10 may be any multi-functional mobile device such as a personal digital assistant (PDA), a portable personal computer (PC), or a multi-media unit. The mobile device 10 includes a processor 20, a configuration memory 30, a main memory 32, a wireless interface 34, a Universal Serial Bus (USB) controller 40, an Infrared Data Association (IrDA) interface 50, a keypad 52, an image sensor 54, a Bluetooth controller 56, a stereo audio codec 60, a display controller 80, and a hybrid imaging display unit 90. The mobile device 10 may include more or less components than the above.

The processor 20 may be any processor with multi-control functionalities. It may be a digital signal processor, a mobile processor, or a micro-controller. It may contain internal memories such as static random access memory (SRAM) and/or electrically erasable programmable read-only memory (EEPROM) to store data and instructions. It may have input/output ports such as parallel port, serial port, or peripheral bus to interface to external devices.

The configuration memory 30 stores configuration data or information to configure the processor 20 in various functional modes. It may be a read-only memory (ROM), a flash memory, or an EEPROM. It may also contain boot code that boots up the system upon power-up. The main memory 32 may include SRAM, dynamic RAM, or flash memory to store instructions or data. The wireless interface 34 provides wireless connection to a wireless network via an antenna 36. The wireless interface 34 may conform to some wireless standard such as the Institute of Electrical and Electronic Engineers (IEEE) 801.11b.

The USB controller 40 provides USB interface to a USB device. It may have a Plug-and-Play (PnP) functionality. The IrDA interface 50 provides infrared communication to a remote device. The keypad 52 includes buttons or keyboard to allow the user to enter data or commands. The image sensor 54 captures image information. It may be a camera having charged-couple devices (CCD's) acting as image sensing elements. The Bluetooth controller 56 provides wireless functionality through short-range radio link to communicate with Bluetooth-enabled devices via an antenna 58.

The stereo audio codec 60 provides audio or bit stream coding and decoding to create stereo outputs to the left and right amplifiers 62 and 64 to stereo speakers 72 and 74, respectively. It also provides audio output to a stereo headphone 76. It receives audio input from a microphone 78 via an amplifier 66.

The display controller 80 generates data for display on the hybrid imaging display unit 90. It may include a buffer memory to store text and graphics. It may include special circuitry to perform graphic manipulation. The hybrid imaging display unit 90 uses hybrid imaging technology to display data under virtually any ambient light condition, including outdoor under sunlight and indoor under low light level. It includes a flat panel display and may consume little power under some operating conditions.

FIG. 1B is a diagram illustrating a processing system 100 in which one embodiment of the invention can be practiced. The processing system 100 includes a processor unit 110, a memory controller hub (MCH) 120, a main memory 130, a graphics processor 135, a hybrid imaging display unit 137, an input/output controller hub (ICH) 140, an interconnect 145, a mass storage device 150, a network interface card 170, a biometric device 175, and input/output (I/O) devices 180₁ to 180_{K}.

The processor unit I 10 represents a central processing unit of any type of architecture, such as processors using hyper threading, security, network, digital media technologies, single-core processors, multi-core processors, embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The MCH 120 provides control and configuration of memory and input/output devices such as the main memory 130 and the ICH 140. The MCH 120 may be integrated into a chipset that integrates multiple functionalities such as graphics, media, host-to-peripheral bus interface, memory control, power management, etc. The MCH 120 or the memory controller functionality in the MCH 120 may be integrated in the processor unit 110. In some embodiments, the memory controller, either internal or external to the processor unit 110, may work for all cores or processors in the processor unit 110. In other embodiments, it may include different portions that may work separately for different cores or processors in the processor unit 110.

The main memory 130 stores system code and data. The main memory 30 is typically implemented with dynamic random access memory (DRAM), static random access memory (SRAM), or any other types of memories including those that do not need to be refreshed.

The graphics processor 135 is any processor that provides graphics functionalities. The graphics processor 135 may also be integrated into the MCH 20 to form a Graphics and Memory Controller Hub (GMCH). The graphics processor 135 may be a graphics card such as the Graphics Performance Accelerator (AGP) card, interfaced to the MCH 20 via a graphics port such as the Accelerated Graphics Port (AGP) controller. It typically has graphic capabilities to perform graphics operations such as fast line drawing, two-dimensional (2-D) and three-dimensional (3-D) graphic rendering functions, shading, anti-aliasing, polygon rendering, transparency effect, color space conversion, alpha-blending, chroma-keying, etc. It may also perform specific and complex graphic functions such as geometry calculations, affine conversions, model view projections, 3-D clipping, etc. The graphics processor 135 provides interface to the hybrid imaging display unit 137. The hybrid imaging display unit 137 is similar to the display unit 80 shown in FIG. 1A. It uses hybrid imaging technology to display data under virtually any ambient light condition, including outdoor under sunlight and indoor under low light level. It includes a flat panel display and may consume little power under some operating conditions.

The ICH 140 has a number of functionalities that are designed to support I/O functions. The ICH 140 may also be integrated into a chipset together or separate from the MCH 120 to perform I/O functions. The ICH 140 may include a number of interface and I/O functions such as peripheral component interconnect (PCI) bus interface, processor interface, interrupt controller, direct memory access (DMA) controller, power management logic, timer, system management bus (SMBus), universal serial bus (USB) interface, mass storage interface, low pin count (LPC) interface, etc.

The interconnect 145 provides interface to peripheral devices. The interconnect 145 may be point-to-point or connected to multiple devices. For clarity, not all the interconnects are shown. It is contemplated that the interconnect 145 may include any interconnect or bus such as Peripheral Component Interconnect (PCI), PCI Express, USB, IEEE 1394, and Direct Media Interface (DMI), etc.

The mass storage device 150 stores archive information such as code, programs, files, data, and applications. The mass storage device 150 may include compact disk (CD) read-only memory (ROM) 152, digital video/versatile disc (DVD) 154, a floppy drive 156, and a hard drive 158, and any other magnetic or optic storage devices. The mass storage device 150 may provide a mechanism to read machine-accessible media that contain instructions or programs to perform the functions described in the following.

The I/O devices 180₁ to 180_{K} may include any I/O devices to perform I/O functions. Examples of I/O devices 180₁ to 180_{K} include controller for input devices (e.g., keyboard, mouse, trackball, pointing device), media card (e.g., audio, video, graphic), network interface card, and any other peripheral controllers.

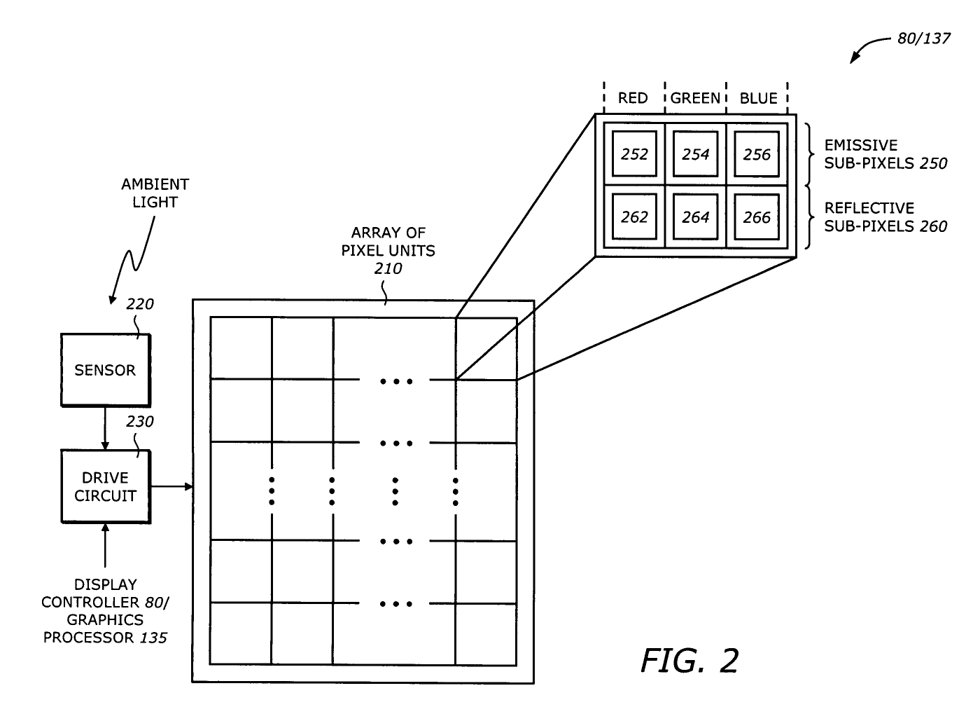

FIG. 2 is a diagram illustrating a hybrid imaging display unit 90/137 according to one embodiment of the invention. The display unit 80/137 includes an array of pixel units 210, a sensor 220, and a drive circuit 230.

The array 210 of pixel units includes pixel units organized in a two-dimensional (2-D) array that works well under both low and high ambient light conditions. Each pixel unit has emissive and reflective sub-pixels as illustrated by a pixel unit 240. The pixel unit 240 has three components: red, blue, and green components for color display. The red, blue, and green components are further divided into the emissive sub-pixels 250 and reflective sub-pixels 260. Each color component has an emissive sub-pixel and a reflective sub-pixel with the same corresponding color. These sub-pixels are located next to each other. The emissive sub-pixels 250 include red, green, and blue emissive sub-pixel 252, 254, and 256, respectively. The reflective sub-pixels 250 include red, green, and blue reflective sub-pixel 262, 264, and 266, respectively. The array of pixel units may be driven by a passive matrix or active matrix driving techniques.

The emissive sub-pixels are electroluminescent elements that emit light under proper biased conditions. They may be formed by overlaying a cathode layer, an emissive polymer layer, a conductive polymer layer, and an anode layer made of indium tin oxide (ITO), and a transparent substrate (e.g., glass). The pattern polymer layers may be formed by any one of techniques such as spin coating, ink jet printing, and screen printing. In one embodiment, the emissive sub-pixels are formed by an organic light emitting diode (OLED) or polymer light emitting diode (PLED) array. The fabrication technique may be efficiently performed by ink jet printing for low cost displays. In a typical manufacturing process using ink jet printing for PLED display, a fine jet of ink is ejected through nozzles having diameters of 10 to 200 μm. The jetted stream is broken up into a series of droplets that are deposited as a dot matrix image on a substrate. The patterning of the red, green, and blue sub-pixels may be performed through an energy transfer from an appropriate buffer layer (e.g., a semiconducting polymer layer) with a wide band-gap to the ink-jet printed materials (or dopants) with smaller band-gaps than the buffer layer.

The reflective sub-pixels reflect light by changing the polarization direction of light passing through them. In one embodiment, the reflective sub-pixels are formed by a bi-stable thin-film transistor (TFT) liquid crystal display (LCD) array. The array may be formed by polarizer layers, a TFT substrate layer, a color filter layer, a common electrode (e.g., ITO) layer, and glass substrate layers. Due to bi-stability, only the sub-pixels being refreshed in an active matrix addressing mode need the driving voltage or current, resulting in low power consumption. The pairing of the OLED/PLED with a bi-stable LCD display is an ideal embodiment.

The sensor 220 senses the ambient light condition and generates a sense signal indicating the intensity or magnitude of the ambient light. When exposed to a bright light condition, such as under the sunlight, the sense signal is at one level indicating a high ambient light condition. When exposed to a dark light condition, such as the indoor environment, the sense signal is at another level indicating a low ambient light condition. It may provide analog or digital output. It may utilize photo-detectors such as photo-transistors that respond to changes in the ambient light. It may suppress infrared spectrum to provide human eye responsiveness to visible light spectrum. Typically, its spectral response peaks at the same wavelength (550 nm) as the human eye. It performs equally well with light sources ranging from natural sunlight to fluorescent, conventional incandescent, and halogen lamps. For digital output, it may include an analog-to-digital converter to provide light measurements over N-bit dynamic range.

The drive circuit 230 receives the sense signal from the sensor 220 and the display data from the display controller 80 (FIG. 1A) or the graphics processor 135 (FIG. 1B). It generates driving signals to drive the array 210 of pixel units according to the sense signal such that the emissive and reflective sub-pixels are switched in a mutually exclusive manner. In other words, when the emissive sub-pixels are turned or switched on, the reflective sub-pixels are turned or switched off. The drive circuit 230 generates the driving signals to switch on the reflective sub-pixels and switch off the emissive pixels when the sense signal indicates a high ambient light condition. It generates the driving signals to switch off the reflective sub-pixels and switch on the emissive pixels when the sense signal indicates a low ambient light condition.

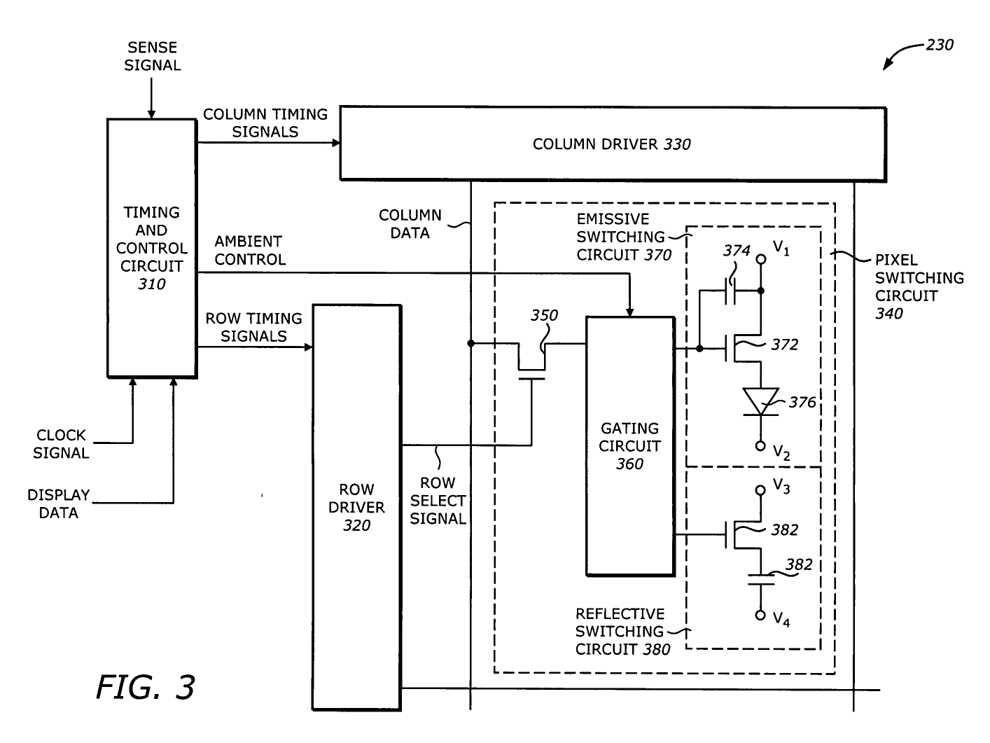

FIG. 3 is a diagram illustrating a drive circuit 230 according to one embodiment of the invention. The drive circuit 230 includes a timing and control circuit 310, a row driver 320, a column driver 330 and a number of pixel switching circuits 340.

The timing and control circuit 310 generates row and column timing signals and an ambient control signal using the clock signal and the display data from the display controller 80 (FIG. 1A) or the graphics processor 135 (FIG. 1B) and the sense signal from the sensor 220 (FIG. 2). It may include a comparator to compare the sense signal with a preset threshold to determine whether the ambient light condition is high or low, corresponding to bright or dark lighting conditions, respectively. The timing and control circuit 310 generate the timing signals using an active address method that drives rows and columns in a continuous manner within pre-defined timing intervals to provide a flicker-free display. The row driver 320 generates row select signals to select rows of the array of pixels according to the row timing signals. The column driver 330 provides column data to columns of the array of pixels according to the column timing signals. The column data may correspond to the display data of the individually addressed sub-pixel.

The pixel switching circuit 340 corresponds to a pixel unit. It is connected to the row and column drivers 320 and 330 to switch the emissive and reflective sub-pixels in the mutually exclusive manner according to the row select signals, the column data, and the ambient control signal. For illustrative purposes, only an emissive sub-pixel and a reflective sub-pixel are shown. As discussed above, for multi-color display, each pixel unit includes three emissive sub-pixels and three reflective sub-pixels. The pixel switching circuit 340 includes a transistor 350, a gating circuit 360, an emissive switching circuit 370, and a reflective switching circuit 380.

The emissive switching circuit 370 includes a transistor 372, a capacitor 374, and a light emitting diode (LED) 376 connected between two voltage levels V₁ and V₂. The reflective switching circuit 380 includes a transistor 382 and a capacitor 384 connected through the two voltage levels V₃ and V₄. The voltage levels V₃ and V₄ may correspond to the appropriate common electrode and pixel electrode levels. The capacitors 374 and 382 retain the charge during the driving or scanning period. The transistor 350 is turned on when its row and column lines are activated indicating that the pixel unit is being addressed by the timing and control circuit 310. The gating circuit 360 gates the ambient control signal to provide control signal to turn on one of the emissive and reflective switching circuits 370 and 380. When the sense signal indicates a high ambient light condition, the gating circuit 360 turns on or off the transistor 372 which in turn energized or de-energized the LED 374 according to the sub-pixel data. At the same time, the gating circuit 360 turns off the transistor 382 to deactivate the reflective sub-pixel. When the sense signal indicates a low ambient light condition, the gating circuit 360 turns on or off the transistor 384 which in turn energized or de-energized the reflective sub-pixel according to the sub-pixel data. At the same time, the gating circuit 360 turns off the transistor 374 to deactivate the emissive sub-pixel. When no display is desired, the gating circuit 360 may turn off both the emissive and reflective switching circuits 370 and 380. The gating circuit 360 may also include direct current (DC) converter circuitry or other bias circuitry to generate appropriate amounts of current or voltage to drive the emissive and reflective switching circuits 370 and 380.

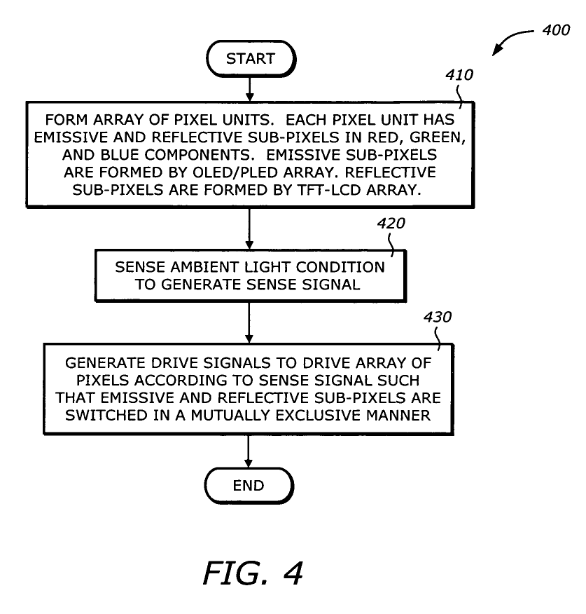

FIG. 4 is a flowchart illustrating a process 400 to display using hybrid imaging according to one embodiment of the invention.

Upon START, the process 400 forms an array of pixel units (Block 410). Each pixel unit has emissive and reflective sub-pixels organized into red, green, and blue components. The emissive sub-pixels are formed by an OLED or PLED array. The reflective sub-pixels are formed by a bi-stable TFT LCD array. Next, the process 400 senses the ambient light condition to generate a sense signal (Block 420).

Then, the process 400 generates driving signals to drive the array of pixel units according to the sense signal such that the emissive and reflective sub-pixels are switched in a mutually exclusive manner (Block 430). The process 400 is then terminated.

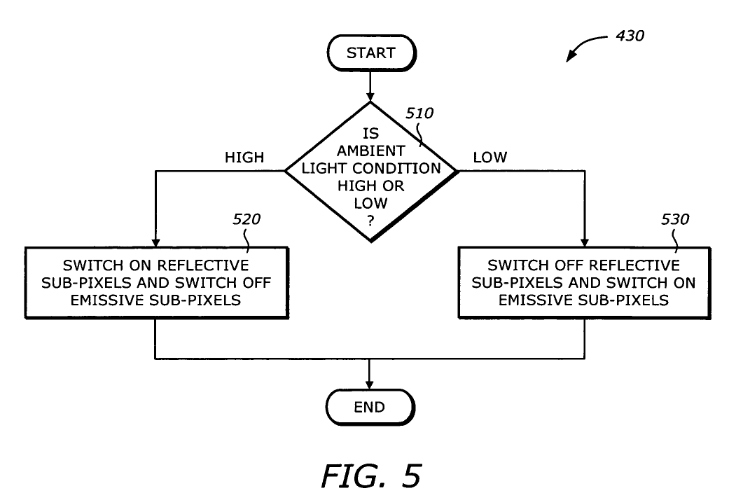

FIG. 5 is a flowchart illustrating the process 430 to generate driving signals according to one embodiment of the invention. The process 430 may be a function or a module in the process 400.

Upon START, the process 430 determines if the ambient light condition is HIGH or LOW based on the sense signal (Block 510). If the ambient light condition is high, the process 430 switches on the reflective sub-pixels and switch off the emissive sub-pixels (Block 520) and is then terminated. If the ambient light condition is low, the process 430 switches off the reflective sub-pixels and switch on the emissive sub-pixels (Block 530) and is then terminated.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. An apparatus comprising:
an array of pixel units, each pixel unit having emissive and reflective sub-pixels;
a sensor to sense ambient light condition, the sensor generating a sense signal; and
a drive circuit coupled to the light sensor to generate driving signals to drive the array of pixel units according to the sense signal such that the emissive and reflective sub-pixels are switched in a mutually exclusive manner.

2. The apparatus of claim 1 wherein each pixel unit has red, green, and blue components.

3. The apparatus of claim 1 wherein the emissive sub-pixels are formed by an organic light emitting diode (OLED) or polymer light emitting diode (PLED) array.

4. The apparatus of claim 1 wherein the reflective sub-pixels are formed by a bi-stable thin-film transistor (TFT) liquid crystal display (LCD) array.

5. The apparatus of claim 1 wherein the drive circuit generates the driving signals to switch on the reflective sub-pixels and switch off the emissive pixels when the sense signal indicates a high ambient light condition.

6. The apparatus of claim 1 wherein the drive circuit generates the driving signals to switch off the reflective sub-pixels and switch on the emissive pixels when the sense signal indicates a low ambient light condition.

7. The apparatus of claim 1 wherein the drive circuit comprises:
a timing and control circuit to generate row and column timing signals and an ambient control signal using the sense signal;
a row driver to generate row select signals to select rows of the array of pixels according to the row timing signals;
a column driver to provide column data to columns of the array of pixels according to the column timing signals; and
a pixel switching circuit coupled to the row and column drivers to switch the emissive and reflective sub-pixels in the mutually exclusive manner according to the row select signals, the column data, and the ambient control signal.

8. A method comprising:
forming an array of pixel units, each pixel unit having emissive and reflective sub-pixels;
sensing ambient light condition to generate a sense signal; and
generating driving signals to drive the array of pixel units according to the sense signal such that the emissive and reflective sub-pixels are switched in a mutually exclusive manner.

9. The method of claim 8 wherein forming comprises:
forming the array of pixel units, each pixel unit having red, green, and blue components.

10. The method of claim 8 wherein forming comprises:
forming the emissive sub-pixels by an organic light emitting diode (OLED) or polymer light emitting diode (PLED) array.

11. The method of claim 8 wherein forming comprises:
forming the reflective sub-pixels by a bi-stable thin-film transistor (TFT) liquid crystal display (LCD) array.

12. The method of claim 8 wherein generating the driving signals comprises:
switching on the reflective sub-pixels and switching off the emissive pixels when the sense signal indicates a high ambient light condition.

13. The method of claim 8 wherein generating the driving signals comprises:
switching off the reflective sub-pixels and switching on the emissive pixels when the sense signal indicates a low ambient light condition.

14. The method of claim 8 wherein generating the driving signals comprises:
generating row and column timing signals and an ambient control signal using the sense signal;
generating row select signals to select rows of the array of pixels according to the row timing signals;
providing column data to columns of the array of pixels according to the column timing signals; and
switching the emissive and reflective sub-pixels in the mutually exclusive manner according to the row select signals, the column data, and the ambient control signal

15. A system comprising:
a processor;
a display data controller coupled to the processor to generate display data; and
a hybrid imaging display unit coupled to the display data controller to display the display data, the hybrid imaging display unit comprising:
an array of pixel units, each pixel unit having emissive and reflective sub-pixels,
a sensor to sense ambient light condition, the sensor generating a sense signal, and
a drive circuit coupled to the sensor to generate driving signals to drive the array of pixel units according to the sense signal such that the
emissive and reflective sub-pixels are switched in a mutually exclusive manner.

16. The system of claim 15 wherein each pixel unit has red, green, and blue components.

17. The system of claim 15 wherein the emissive sub-pixels are formed by an organic light emitting diode (OLED) or polymer light emitting diode (PLED) array.

18. The system of claim 15 wherein the reflective sub-pixels are formed by a bi-stable thin-film transistor (TFT) liquid crystal display (LCD) array.

19. The system of claim 15 wherein the drive circuit generates the driving signals to switch on the reflective sub-pixels and switch off the emissive pixels when the sense signal indicates a high ambient light condition.

20. The system of claim 15 wherein the drive circuit generates the driving signals to switch off the reflective sub-pixels and switch on the emissive pixels when the sense signal indicates a low ambient light condition.

21. The system of claim 15 wherein the drive circuit comprises:
a timing and control circuit to generate row and column timing signals and an ambient control signal using the sense signal;
a row driver to generate row select signals to select rows of the array of pixels according to the row timing signals;
a column driver to provide column data to columns of the array of pixels according to the column timing signals; and a pixel switching circuit coupled to the row and column drivers to switch the emissive and reflective sub-pixels in the mutually exclusive manner according to the row select signals, the column data, and the ambient control signal.
